(19) United States
(12) Patent Application Publication
(10) Pub. No.: US 2011/0239957 A1
(43) Pub. Date: Oct. 6, 2011

(54) PET WASTE CARRIER

(76) Inventor: Rhonda Lee Washington, Milwaukee, WI (US)

(21) Appl. No.: 12/955,128

(22) Filed: Nov. 29, 2010

Related U.S. Application Data
(60) Provisional application No. 61/321,200, filed on Apr. 6, 2010.

(51) Int. Cl. A01K 23/00

(52) U.S. Cl. 119/858; 119/868

(57) ABSTRACT

A pet waste carrier that is temporarily carried by the pet until an adequate disposal station can be reached. The pet waste carrier includes a first pocket, a second pocket, a front strap having one end connected to the first pocket and the other end connected to the second pocket, a neck strap having one end connected to the front strap and another end connected to the other end of the front strap, a first side strap having one end connected to the first pocket and the other end connected to the second pocket; and a second side strap having one end connected to the first pocket and the other end connected to the second pocket.

### CROSS-REFERENCE TO RELATED APPLICATIONS

This application claims the benefit of Provisional Application No. 61/321,200 filed Apr. 06, 2010, the contents of which are incorporated herein by reference.

### BACKGROUND OF THE INVENTION

The present invention generally relates to storage pouches for pet waste. More specifically, the present invention relates to a storage pouch for pet waste that is carried by the actual pet.

Pet owners frequently take their animals for walks in public places. Unfortunately, the pets may defecate during the walk forcing the pet owner to pick up the pet waste in order to comply with local laws. It is common practice for pet owners to use small plastic bags to pick up the pet waste. Many pet owners find that carrying the plastic bags filled with animal waste by hand is unpleasant.

As can be seen, there is a need for a device to carry pet waste that is temporarily carried by the pet until an adequate disposal station can be reached.

### SUMMARY OF THE INVENTION

In one aspect of the present invention, a pet waste carrier includes a first pocket, a second pocket, a front strap having one end connected to the first pocket and the other end connected to the second pocket, a neck strap having one end connected to the front strap and another end connected to the other end of the front strap, a first side strap having one end connected to the first pocket and the other end connected to the second pocket; and a second side strap having one end connected to the first pocket and the other end connected to the second pocket.

These and other features, aspects and advantages of the present invention will become better understood with reference to the following drawings, description and claims.

### BRIEF DESCRIPTION OF THE DRAWINGS

FIG. 1 illustrates a perspective side view of a pet waste carrier according to an exemplary embodiment of the present invention showing the pet waste carrier in use;

FIG. 2 illustrates a perspective side view of the pet waste carrier of FIG. 1;

FIG. 3 illustrates a back view of the pet waste carrier of FIG. 1; and

FIG. 4 illustrates a top view of the pet waste carrier of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a pet waste carrier that is temporarily carried by the pet until an adequate disposal station can be reached.

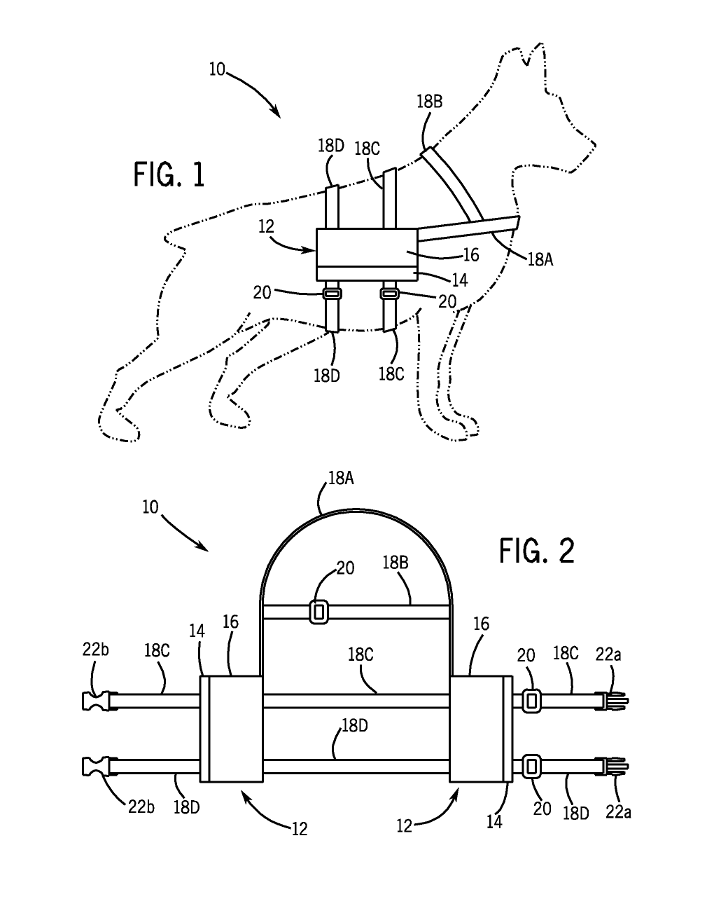

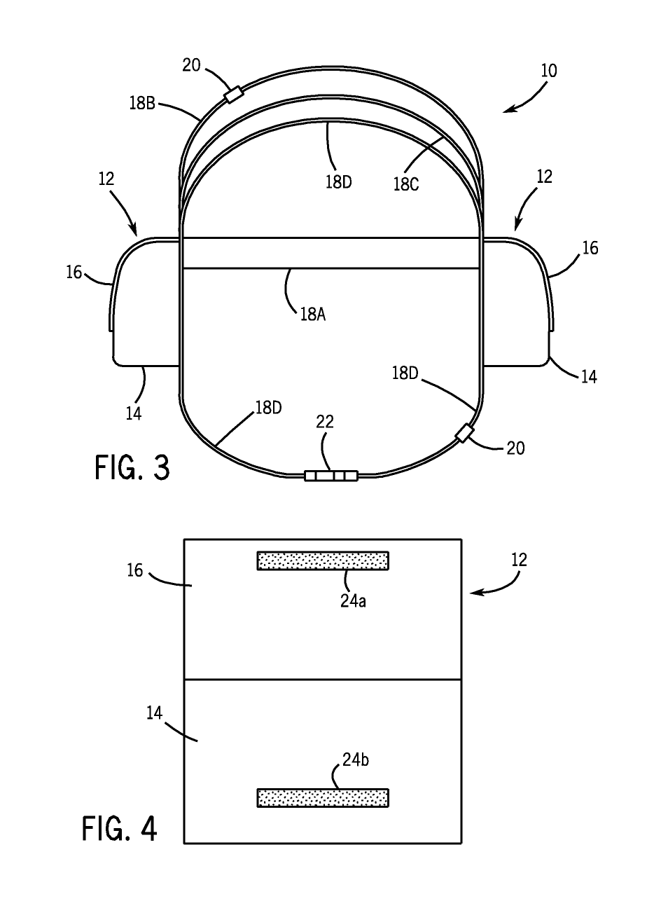

FIG. 1 illustrates the pet waste carrier 10 according to an exemplary embodiment of the present invention. The pet waste carrier 10 may include a first pocket 12, a second pocket 12, a forward strap 18A, a neck strap 18B, a first side strap 18C, and a second side strap 18D.

The pockets 12 may be configured and designed to have a shape that allows a pet to carry its own feces so that the owner may not have to carry or smell it. In one embodiment, the pockets 12 may have a rectangular, triangular, round, square, pentagonal, of hexagonal shape. The pockets 12 may be made of a lightweight and waterproof material. In one embodiment, the pockets 12 may be made of canvas, fabric, plastic, leather, or nylon. In one embodiment, the pockets 12 may include a body 14 and a cover flap 16 to cover the body 14. The pockets 12 may be placed on opposite sides of the body of the pet. One of the pockets 12 may be adapted to receive plastic bags used to pick up the waste. The other pocket 12 may be adapted to receive the plastic bag including the pet waste. Each pocket 12 may include a fastening device 24a and 24b to permit closing and re-opening the cover flap 16. In one embodiment, the fastening device 24a and 24b may be hoop and loop, a button, a zipper, a clasp, or a clip. In one embodiment, the pet waste carrier 10 may have more than two pockets 12. In one embodiment, the pet waste carrier 10 may have one pocket 12.

A forward strap 18A may have one end connected to the pocket 12 and may extend in a semi-circular path from one side of the first pocket 12 around the base of the pet neck, and to the other side of the second pocket 12.

A neck strap 18B may extend from one side of the forward strap 18A, along the pet's back, and to another side of the forward strap 18A. The neck strap 18B may be sewn into the forward strap 18A. The neck strap 18B may include a length adjustment device 20. In one embodiment, the length adjustment device 20 may be a tri-glide adjustment clip.

The first side strap 18C may be sewn onto one side of the first pocket 12 and may go around the pet starting from the one side of the pet's ribs, across the back of the pet, connect with the second pocket 12, and across the belly of the pet, until it reaches the other side of the first pocket 12.

The second side strap 18D may be parallel to the first side strap 18C. The second side strap 18C may follow the same path as the first side strap 18C.

The first side strap 18C and the second side strap 18D may include coupling devices 22. The coupling device 22 may include a first coupling part 22a attached to one end of the straps 18C and 18D and a second coupling part 22b attached to the opposite end of the straps 18C and 18D. In one embodiment, the coupling device 22 may include interconnecting clips, female and male interconnectors, hoop and loop connectors, buckles, or a button and opening system.

The length of each one of the straps 18A-18D may depend on the pet size. In one embodiment, the length of the straps 18A-18D may be adjustable.

The straps 18A-18D may be made of a strong material. In one embodiment, the straps 18A-18D may be made of nylon, fabric, or leather.

The user may place the front strap 18A around the neck of the pet, the neck strap 18B around the back of the neck of the pet, hang a pocket 12 on each side of the pet, wrap the side straps 18C-18D around the body of the pet and fasten the side straps by using the coupling device 22.

In one embodiment, the carrier 10 of the present invention may be use to carry small items. In addition, the pockets 12 may include decorations. In one embodiment, the decorations may includes, letters, numbers, stars, flowers, gems, holidays motives, or geometrical figures.

It should be understood, of course, that the foregoing relates to exemplary embodiments of the invention and that modifications may be made without departing from the spirit and scope of the invention as set forth in the following claims.

We claim:

1. A pet waste carrier comprising:
a first pocket;
a second pocket;
a front strap having a first end and a second end, wherein the first end of the front strap is connected to the first pocket, wherein the second end of the front strap is connected to the second pocket;
a neck strap having a first end and a second end, wherein the first end of the neck strap is connected to the front strap near the first end of the front strap, wherein the second end of the neck strap is connected to the front strap near the second end of the front strap;
a first side strap having a first end and a second end, wherein the first end of the first strap is connected to the first pocket, wherein the second end of the first side strap is connected to the second pocket; and
a second side strap having a first end and a second end, wherein the first end of the second strap is connected to the first pocket, wherein the second end of the second side strap is connected to the second pocket.

2. The pet waste carrier of claim 1, wherein the first pocket and the second pocket further include a cover flap.

3. The pet waste carrier of claim 1, wherein the cover flap includes a fastening device.

4. The pet waste carrier of claim 1, wherein the front strap is adapted to pass around a chest of the pet.

5. The pet waste carrier of claim 1, wherein the neck strap is adapted to pass around a back of a neck of the pet.

6. The pet waste carrier of claim 1, wherein the first side strap and the second side strap are adapted to pass from the first pocket to a back of the pet, around a belly of the pet, and to the second pocket.

7. The pet waste carrier of claim 1, wherein the first side strap and the second side strap are parallel.

8. The pet waste carrier of claim 1, wherein the front strap, the neck strap, and the side straps have a length that is adjustable.

9. The pet waste carrier of claim 1, wherein the pockets and the straps are sewn together.
